(19) United States
(12) Patent Application Publication
(10) Pub. No.: US 2007/0222817 A1
(43) Pub. Date: Sep. 27, 2007

(54) METHODS AND APPARATUS FOR INKJET PRINTING USING MULTIPLE SETS OF PRINT HEADS

(76) Inventors: Shinichi Kurita, San Jose, CA (US); Quanyuan Shang, Saratoga, CA (US); John M. White, Hayward, CA (US)

Correspondence Address: DUGAN & DUGAN, PC, 55 SOUTH BROADWAY, TARRYTOWN, NY, 10591, US

(21) Appl. No.: 11/690,507

(22) Filed: Mar. 23, 2007

Related U.S. Application Data
(60) Provisional application No. 60/785,594, filed on Mar. 24, 2006.

(51) Int. Cl. B41J 2/15

(52) U.S. Cl. 347/40

(57) ABSTRACT

In a first aspect, a system is provided for inkjet printing. The system includes (1) a first set including a first inkjet print head having a first plurality of nozzles adapted to selectively dispense a first ink, and a second inkjet print head having a second plurality of nozzles adapted to selectively dispense a second ink, (2) a second set including a third inkjet print head having a third plurality of nozzles adapted to selectively dispense a third ink and a fourth inkjet print head having a fourth plurality of nozzles adapted to selectively dispense a fourth ink and (3) a stage adapted to support and transport the substrate below the first and second sets during a printing pass such that the first set and second sets are adapted to dispense respective first/second and third/fourth inks into adjacent color wells of a display pixel on a substrate.

### CROSS-REFERENCE TO RELATED APPLICATIONS

This patent application claims priority from U.S. Provisional Patent Application Ser. No. 60/785,594, filed Mar. 24, 2006 and titled “METHODS AND APPARATUS FOR INKJET PRINTING” (Attorney Docket No. 9521/L04/DISPLAY/AKT/RKK), which is hereby incorporated by reference herein in its entirety.

Further, the present application is related to the following commonly-assigned, co-pending U.S. Patent Applications, each of which is hereby incorporated herein by reference in its entirety for all purposes:

U.S. Provisional Patent Application Ser. No. 60/625,550, filed Nov. 4, 2004 and entitled “APPARATUS AND METHODS FOR FORMING COLOR FILTERS IN A FLAT PANEL DISPLAY BY USING INKJETTING” (Attorney Docket No. 9521/L);

U.S. patent application Ser. No. 11/019,967, filed Dec. 22, 2004 and titled “APPARATUS AND METHODS FOR AN INKJET HEAD SUPPORT HAVING AN INKJET HEAD CAPABLE OF INDEPENDENT LATERAL MOVEMENT” (Attorney Docket No. 9521-1);

U.S. patent application Ser. No. 11/019,930, filed Dec. 22, 2004 and titled “METHODS AND APPARATUS FOR ALIGNING PRINT HEADS” (Attorney Docket No. 9521-3);

U.S. patent application Ser. No. 10/781,953, filed Feb. 19, 2004 and titled “METHODS AND APPARATUS FOR POSITIONING A SUBSTRATE RELATIVE TO A SUPPORT STAGE” (Attorney Docket No. 8166);

U.S. Provisional Patent Application 60/703,146, filed Jul. 28, 2005 and titled “METHODS AND APPARATUS FOR SIMULTANEOUS INKJET PRINTING AND DEFECT INSPECTION” (Attorney Docket No. 9521-L02 (formerly 9521-7));

U.S. patent application Ser. No. 11/212,043 filed Aug. 25, 2005 and entitled “METHODS AND APPARATUS FOR ALIGNING INKJET PRINT HEAD SUPPORTS” (Attorney Docket No. 9521-6); and

U.S. patent application Ser. No. 11/466,507 filed Aug. 23, 2006 and entitled “METHODS AND APPARATUS FOR INKJET PRINTING COLOR FILTERS FOR DISPLAYS USING PATTERN DATA” (Attorney Docket No. 9521-P04).

### FIELD OF THE INVENTION

The present invention relates generally to flat panel display manufacturing, and more particularly to methods and apparatus for inkjet printing.

### BACKGROUND

The flat panel display industry has been attempting to employ inkjet printing to manufacture display devices, in particular, color filters. One problem with effective employment of inkjet printing is that it is difficult to inkjet ink or other material accurately and precisely on a substrate while having high throughput. Accordingly, there is a need for improved methods and apparatus for efficiently positioning inkjet heads above drop locations on a substrate (e.g., so as to reduce the number of printing passes required for depositing ink on the substrate).

### SUMMARY OF THE INVENTION

In a first aspect of the invention, a system is provided for inkjet printing. The system comprises: (1) a first set including a first inkjet print head having a first plurality of nozzles adapted to selectively dispense a first ink, and a second inkjet print head having a second plurality of nozzles adapted to selectively dispense a second ink; (2) a second set including a third inkjet print head having a third plurality of nozzles adapted to selectively dispense a third ink and a fourth inkjet print head having a fourth plurality of nozzles adapted to selectively dispense a fourth ink; and (3) a stage adapted to support the substrate and transport the substrate below the first and second sets during a printing pass such that the first set is adapted to dispense the first and second inks into respective adjacent color wells of a display pixel on a substrate and the second set is adapted to dispense the third and fourth inks into respective adjacent color wells of a display pixel on a substrate.

In a second aspect of the invention, a first method of inkjet printing is provided. The first method includes the steps of: (1) grouping a first plurality of inkjet print heads into a first set; (2) grouping a second plurality of inkjet print heads into a second set; (3) moving a substrate under the first and second sets in a print direction during a printing pass; and (4) employing both the first set and the second set to dispense ink onto a display object on a substrate during the printing pass.

In a third aspect of the invention, an apparatus is provided for inkjet printing. The apparatus includes: (1) a first set including a first inkjet print head having a first plurality of nozzles adapted to selectively dispense a first ink, and a second inkjet print head having a second plurality of nozzles adapted to selectively dispense a second ink; and

(2) a second set including a third inkjet print head having a third plurality of nozzles adapted to selectively dispense a third ink and a fourth inkjet print head having a fourth plurality of nozzles adapted to selectively dispense a fourth ink such that the first set is adapted to dispense the first and second inks into respective adjacent color wells of a display pixel on a substrate and the second set is adapted to dispense the third and fourth inks into respective adjacent color wells of a display pixel on a substrate.

Other features and aspects of the present invention will become more fully apparent from the following detailed description, the appended claims and the accompanying drawings.

### BRIEF DESCRIPTION OF THE DRAWINGS

FIG. 1 is a schematic diagram of a system for inkjet printing in accordance with an embodiment of the present invention.

FIG. 2A is a schematic diagram of a top view of a portion of an apparatus for inkjet printing in accordance with an embodiment of the present invention.

FIG. 2B is a schematic diagram of an enlarged top view of a portion of the apparatus for inkjet printing shown in FIG. 2A in accordance with an embodiment of the present invention.

FIG. 3 illustrates a method of inkjet printing in accordance with an embodiment of the present invention.

FIG. 4 is a schematic diagram of a top view of an apparatus for inkjet printing in accordance with an embodiment of the present invention.

FIG. 5 is a schematic diagram of a top view of an apparatus for inkjet printing in accordance with an embodiment of the present invention.

FIG. 6 is a schematic diagram of a perspective view of an apparatus for inkjet printing in accordance with an embodiment of the present invention.

FIG. 7 is a schematic diagram of a top view of an apparatus for inkjet printing in accordance with an embodiment of the present invention.

FIG. 8 is a schematic diagram of a top view of an apparatus for inkjet printing in accordance with an embodiment of the present invention.

### DETAILED DESCRIPTION

The present invention provides methods and apparatus for improving printing efficiency by reducing the number of times a substrate is required to pass under an inkjet printer head, particularly when printing using multiple print heads adapted to print on a wide variety of differently sized substrates. According to the present invention, multiple sets of print heads may be arranged to dispense ink onto a substrate as the substrate is transported below the sets. Each set may include more than one print head disposed such that the set is operable to dispense a different ink into adjacent or non-adjacent sub-pixel wells of display pixels on the substrate. This may be achieved by using a different print head for each color ink and offsetting the print heads within a set relative to each other in a direction perpendicular to the print direction by an offset amount (e.g., an offset distance). Additionally or alternatively, the above functionality may be achieved by rotating the sets of print heads about a central axis such that a center-to-center distance in a direction perpendicular to the print direction between corresponding nozzles of adjacent print heads is approximately equal to a center-to-center distance of adjacent color wells of the display pixels. For example, and as described further below, using three sets of print heads, each set including three print heads (e.g., nine print heads in total), three different inks may be deposited into each display pixel of a display object in one third the number of printing passes required by conventional systems. In some embodiments, each set may be used to print a different display object (or column of display objects).

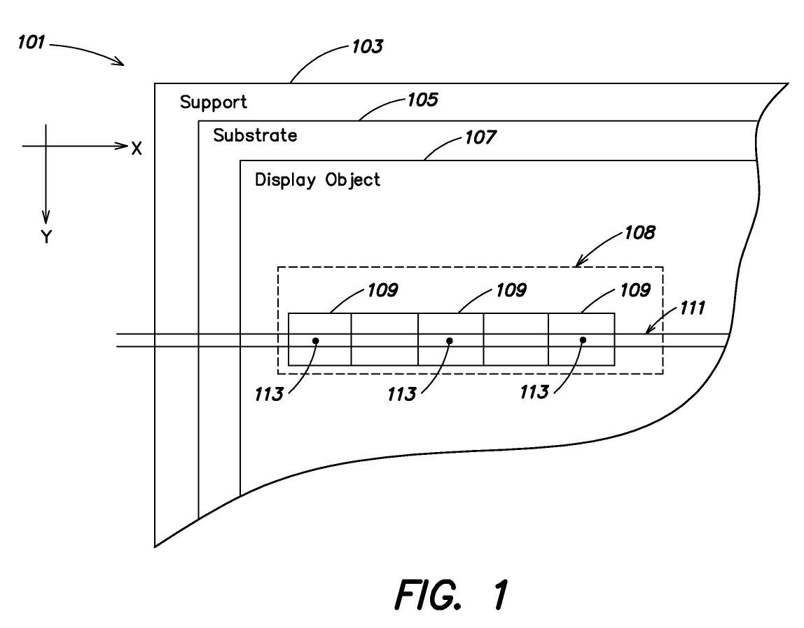

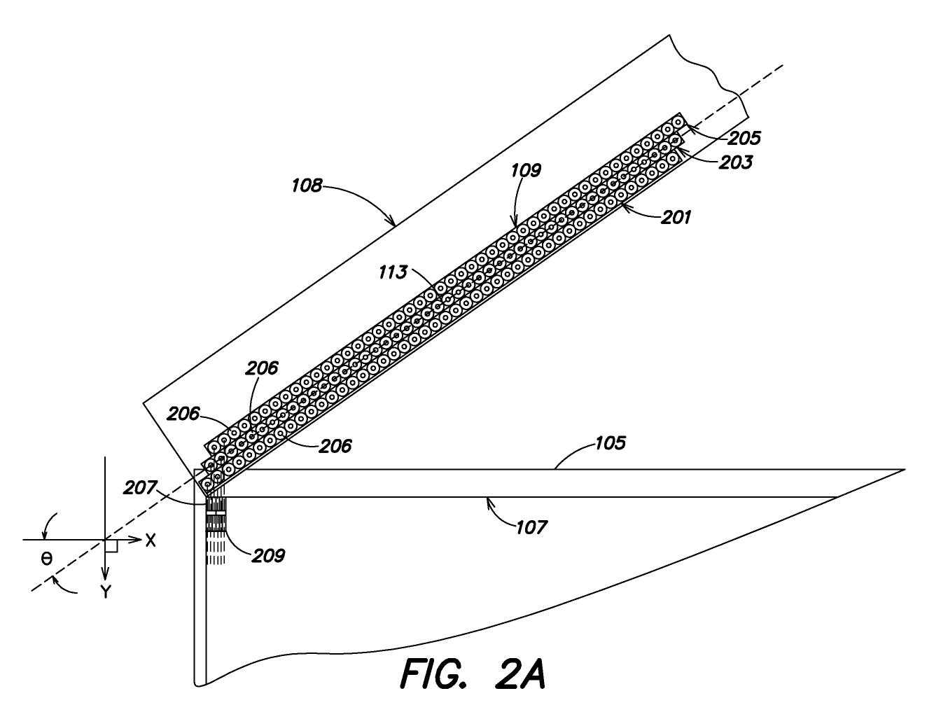

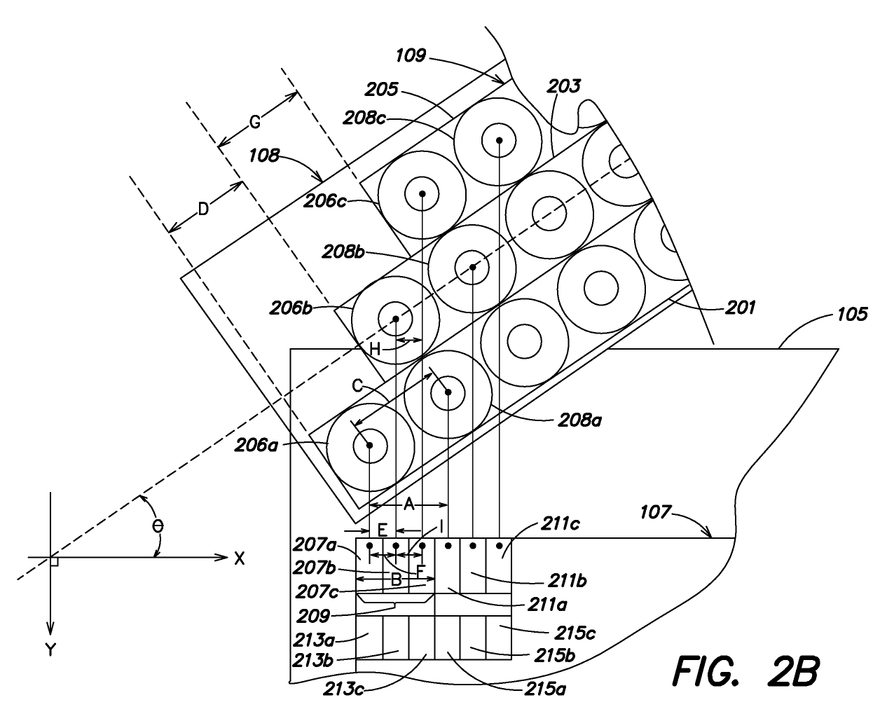

FIG. 1 is a schematic diagram of a system for inkjet printing in accordance with an embodiment of the present invention. With reference to FIG. 1, the system 101 may include a support 103 or stage adapted to support and transport one or more substrates 105 during flat panel display manufacturing or the like, and more specifically, during inkjet printing. Note that differently sized substrates 105 may be used. In one or more embodiments, the substrates 105 may comprise a ‘20K’ substrate having dimensions of 1300 mm by 1500 mm and/or a ‘60K’ substrate, having dimensions of 2600 mm by 2230 mm. The substrates 105 may be placed on the support 103 such that either the longer or shorter side is aligned in the printing (y-axis) direction. The substrates 105 may each include one or more display objects 107 into which ink may be dispensed during inkjet printing. The display objects 107 on the substrates 105 may be of different sizes and configurations. For example, a given substrate 105 may include eight display objects 107 of the same size arranged in four rows and three columns (i.e., a 4×3 configuration), six display objects of somewhat larger size arranged in three rows and two columns (a 3×2 configuration) or two larger display objects arranged one on top of the other in the printing (y-axis) direction. Additionally and/or alternatively, the individual display objects 107 on a given substrate may of different sizes. The display objects 107 may preferably cover substantially the entire surface of the substrates 105; alternatively, the display objects 107 may cover a portion of the surface of the substrates 105. As discussed further below with reference to FIGS. 2A and 2B, the one or more display objects 107 of the substrates 105 may include pixel areas containing sub-pixels adapted to receive dispensed ink. While only one substrate with one display object is shown in FIG. 1, it will be understood that more than one substrate 105 that each include more than one display object 107 may be used. Note that a substrate 105 may be comprised of glass, polymers, and/or any other suitable material.

The system 101 may include one or more apparatus 108 for inkjet printing in accordance with an embodiment of the present invention. Each of the one or more apparatus 108 may include one or more sets 109 of inkjet print heads (not separately shown) adapted to dispense ink into the display objects 107 of the substrate 105. Although the example apparatus 108 includes three sets 109 of inkjet print heads, in some embodiments, the apparatus 108 may include a larger or smaller number of sets 109.

The one or more sets 109 of print heads may be coupled above the substrate support 103. More specifically, the system 101 for inkjet printing may include a supporting bridge 111 which extends above the support 103, to which the one or more sets 109 of print heads are coupled. Although not depicted, in some embodiments, the system 101 for inkjet printing may include more than one bridge 111, wherein each bridge 111 includes one or more sets 109 of print heads. As will be described below, each set 109 may be coupled to the bridge 111 such that the set 109 may independently rotate (e.g., about a central axis 113) above the support 103. In addition, each set 109 may be independently moveable laterally (e.g., along an axis) above the support 103. Further, within each set 109, individual print heads may be moveable relative to each other along a longitudinal axis of the print heads, along an axis that is perpendicular to the longitudinal axis of the print heads, and rotationally (assuming the individual print heads are spaced sufficiently so as not to interfere with each other). Additionally, as described in previously incorporated U.S. patent application Ser. No. 11/212,043, the bridge 111 may be rotatable so as to adjust to the alignment of a display object 107 on the substrate 105.

During inkjet printing, the support 103 may transport the substrate 105 below the one or more sets 109 of inkjet print heads and such sets 109 of inkjet print heads may dispense one or more inks onto one or more display objects 107 included in the substrate 105. In some embodiments, the support 103 transports the substrate 105 along the y-axis, thereby defining a print direction. However, in other embodiments, the support 103 may transport the substrate 105 in a different direction. Each time the support 103 transports the substrate 105 below the one or more sets 109 may be referred to as a printing pass.

FIG. 2A is a schematic diagram of a top view of a portion of the apparatus 108 of FIG. 1. With reference to FIG. 2A, as stated, the apparatus 108 for inkjet printing may include one or more sets 109 of inkjet print heads (only one of which is shown in FIG. 2A). Each of the one or more sets 109 may include a plurality of inkjet print heads 201-205 adapted to dispense respective inks. Note that in FIG. 2A the inkjet print heads 201-205 are represented schematically as being adjacent each other. However, in some embodiments, the print heads 201-205 may be spaced apart a significant distance to allow the print heads to independently rotate. Each print head 201-205 may include a plurality of nozzles 206 adapted to selectively dispense ink (e.g., red, green, blue and/or another color). In some embodiments, a set 109 may include three inkjet print heads 201-205 (although a larger or smaller number of inkjet print heads 201-205 may be employed). Further, in some embodiments, each of the inkjet print heads 201-205 may dispense different inks (e.g., inks of different colors) and/or other fluids or materials. However, in some embodiments, two or more of the print heads 201-205 may dispense the same ink (e.g., ink of the same color) and/or other fluids or materials.

The display object 107 may include a plurality of display pixels 209 each of which may include a plurality of sub-pixel color wells 207 into which ink may be dispensed. The plurality of inkjet print heads 201-205 in the set 109 may be arranged such that the set 109 is adapted to dispense a first ink from a first print head 201, a second ink from a second print head 203, and so on (e.g., a third ink from a third print head 205), into respective adjacent color wells 207 of a display pixel 209 on a substrate 105 during a printing pass. More specifically, to achieve the above result, the set 109 (or individual print heads 201-205) may be rotated (e.g., by an angle θ relative to an x-axis) about a central axis 113 (FIG. 1). Additionally or alternatively, one or more of the plurality of print heads 201-205 (e.g., the first 201 and third print heads 205) may be offset (e.g., along a longitudinal axis of such print heads 201, 205) from remaining print heads (e.g., the second print head 203) in the set 109. The rotating and/or offsetting of the print heads may be effected by independently operable drive motors (or other drivers) for each print head. Details of such rotating and/or offsetting are described below with reference to FIG. 2B.

Although rotating and/or offsetting are described below, it should be understood that any method may be employed to arrange the plurality of print heads 201-205 within each set 109 such that the set 109 is adapted to dispense a first ink from a first print head 201 and a second ink from a second print head 203 into respective adjacent color wells 207 of a display pixel 209. In other words, the rotating may be performed on individual print heads or on an entire set of print heads. Likewise, the offsetting may be performed on individual print heads or on an entire set of print heads. In this manner, a number of printing passes required to dispense the inks from the plurality of inkjet print heads 201-205 into respective adjacent color wells 207 of display pixels 209 on the substrate 105 during inkjet printing may be reduced. Likewise, although the examples described herein consider a set with three print heads and offsets based upon a center print head, any number of print heads may be employed and the center of the set may shift as differently sized sets with different numbers of print heads are employed. Also, although only one set 109 of the apparatus 108 for inkjet printing is illustrated in FIG. 2A, it should be understood that remaining sets 109 in the apparatus 108 are adapted to dispense ink in a similar manner into display pixels 209 traveling under such sets 109 during a printing pass.

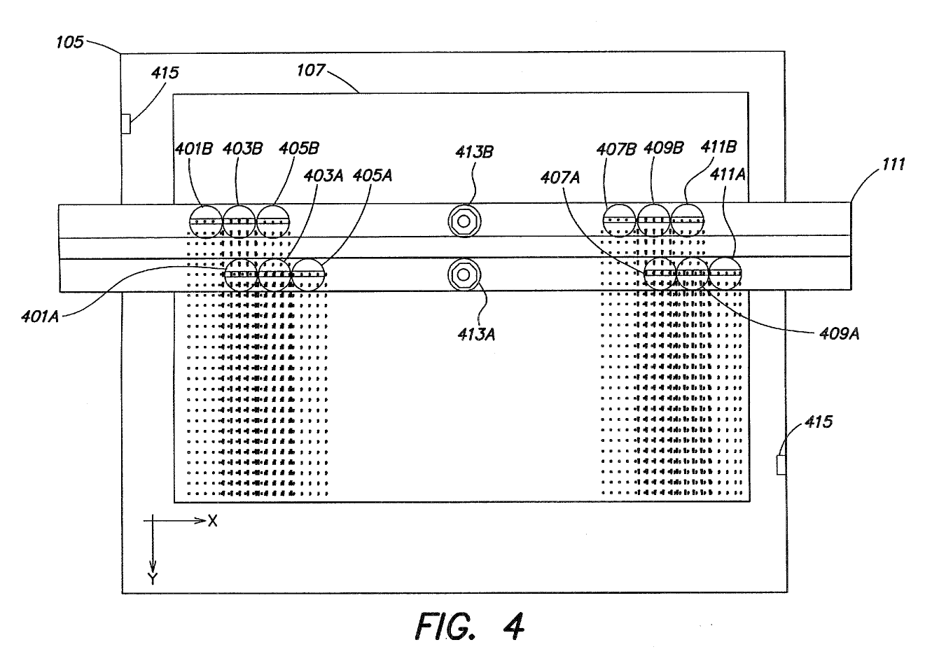

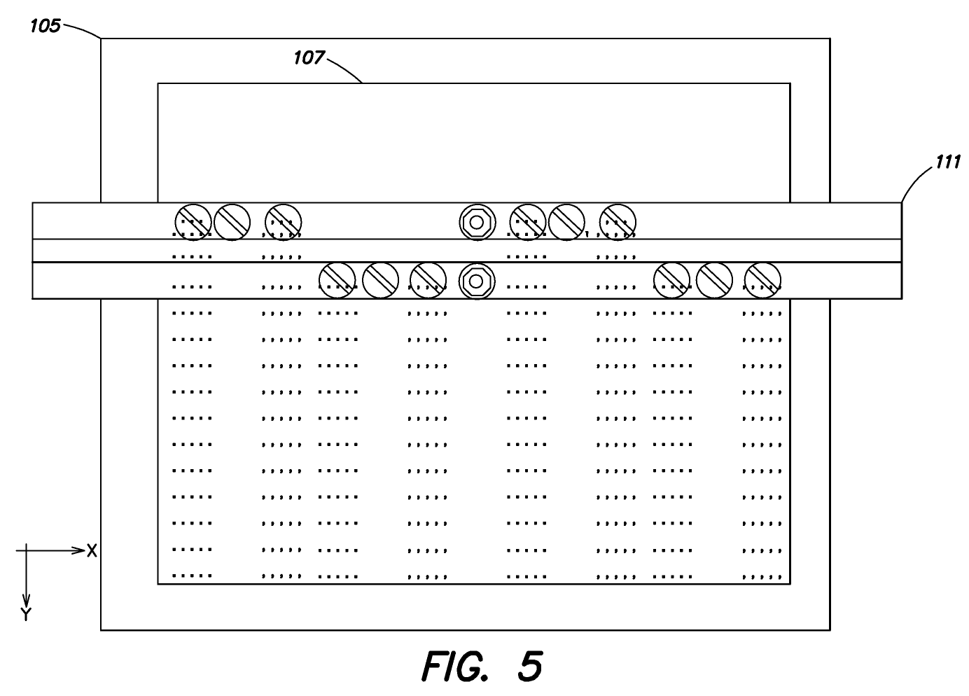

Further, the print heads 201-205 in the same set may be aligned so that different print heads 201-205 deposit ink (e.g., the same color ink) in different display pixels 209. For example, FIG. 4 depicts an arrangement in which six sets 401A & B; 403A & B; 405A & B; 407A & B; 409A & B; and 411A & B of two print heads each are mounted on a bridge 111 such that the first set includes a first print head 401A dispensing a first color ink (e.g., red) (droplets of which are illustrated as periods in FIGS. 4 and 5) mounted on the front of the bridge 111 and a second print head 401B dispensing the same (first) color ink mounted on the rear of the bridge 111; the second set includes a first print head 403A dispensing a second color ink (e.g., green) (droplets of which are illustrated as single quotes in FIGS. 4 and 5) mounted on the front of the bridge 111 and a second print head 403B dispensing the same (second) color ink mounted on the rear of the bridge 111; the third set includes a first print head 405A dispensing a third color ink (e.g., blue) (droplets of which are illustrated as commas in FIGS. 4 and 5) mounted on the front of the bridge 111 and a second print head 405B dispensing the same (third) color ink mounted on the rear of the bridge 111; the fourth set includes a first print head 407A dispensing the first color ink (e.g., red) mounted on the front of the bridge 111 and a second print head 407B dispensing the same (first) color ink mounted on the rear of the bridge 111; the fifth set includes a first print head 409A dispensing the second color ink (e.g., green) mounted on the front of the bridge 111 and a second print head 409B dispensing the same (second) color ink mounted on the rear of the bridge 111; and the sixth set includes a first print head 411A dispensing the third color ink (e.g., blue) mounted on the front of the bridge 111 and a second print head 411B dispensing the same (third) color ink mounted on the rear of the bridge 111. Note that, as depicted in FIG. 4, the ink from the first print head 4XXA in each set may be deposited in display pixels adjacent display pixels in which ink from the second print head 4XXB in each set may be deposited. In other words, the offset in the Y-direction between the two print heads of each set (due to one print head 4XXA in each set being mounted on the front of the bridge 111 and one print head 4XXB in each set being mounted on the rear of the bridge 111) allows the print heads' respective columns of ink drops to be deposited any desired distance apart in the X-direction (including overlapping).

FIG. 2B is a schematic diagram of an enlarged top view of a portion of the apparatus for inkjet printing shown in FIG. 2A in accordance with an embodiment of the present invention. With reference to FIG. 2B, the plurality of print heads 201-205 are arranged within the set 109 such that the set 109 may dispense a first ink from a first nozzle 206a of the first print head 201 into a first color well 207a, a second ink from a first nozzle 206b of the second print head 203 into a second color well 207b that is adjacent the first color well 207a, and so on (e.g., the set may be adapted to dispense a third ink from a first nozzle 206c of the third print head 205 into a third color well 207c that is adjacent the second color well 207b), as the support 103 transports the substrate 105 in the printing direction (e.g., along the y-axis) below the apparatus 108 (e.g., during a printing pass). Similarly, the set 109 may dispense ink into color wells of other display pixels 209. For example, the set 109 may dispense the first ink from a second nozzle 208a of the first print head 201 into a fourth color well 211a included in another display pixel, the second ink from a second nozzle 208b of the second print head 203 into a fifth color well 211b that is adjacent the fourth color well 211a, and so on (e.g., the set may be adapted to dispense the third ink from a second nozzle 208c of the third print head 205 into a sixth color well 211c that is adjacent the fifth color well 211b), during the printing pass. Further, the set 109 may dispense ink into color wells 213a-c, 215a-c as the support 103 transports such color wells below the set 109. In this manner, the set 109 may dispense ink into color wells 207a-c, 211a-c, 213a-c, 215a-c of display pixels 209 during the printing pass. Further, although FIG. 2B illustrates ink dispensed from two nozzles 206, 208 of each of the first through third print heads 201-205, it should be understood that the set 109 may be adapted to dispense ink from remaining nozzles of the plurality of print heads 201-205 in a manner similar to that described above such that ink may be deposited into one or more additional display pixels 209 (not shown) included in the display object 107 during the printing pass.

To achieve the above-described arrangement of the plurality of print heads 201-205 within the set 109, the set 109 may be rotated (e.g., by an angle θ relative to the x-axis) about a central axis (not shown in FIG. 2B; 113 in FIG. 2A) such that a center-to-center distance A along an axis (e.g., x-axis) perpendicular to the printing direction (e.g., y-axis) of adjacent nozzles in a print head 201-205 is substantially or approximately equal to the display pixel width B. In one embodiment, the display pixel width is 120 microns (although a larger or smaller width may be employed). In some embodiments, the angle of rotation θ may be cos⁻¹ (A/C), where C is the center-to-center distance between adjacent nozzles of a print head along a longitudinal axis of the print head as shown in FIG. 2B. However, the angle of rotation θ may be based on a different relationship.

Additionally or alternatively, the first print head 201 may be offset in a first direction (e.g., along a longitudinal axis of such print head 201) by an amount D from the second print head 203 such that a center-to-center distance E in a direction (e.g., along the x-axis) perpendicular to the print direction (e.g., along the y-axis) between corresponding nozzles (e.g., 206a and 206b) of such print heads 201-203 is approximately equal to a center-to-center distance F of adjacent color wells (e.g., 207a and 207b) of the display pixel 209.

Similarly, the third print head 205 may be offset in a second direction (e.g., along a longitudinal axis of such print head 201) by an amount G from the second print head 203 such that a center-to-center distance H in a direction (e.g., along the x-axis) perpendicular to the print direction (e.g., along the y-axis) between corresponding nozzles (e.g., 206c and 206b) of such print heads 203,205 is approximately equal to a center-to-center distance I of adjacent color wells (e.g., 207b and 207c) of the display pixel 209. In some embodiments, dimensions D, E and F may match dimensions G, H and I, respectively (although dimensions D, E and F may differ from dimensions G, H and I, respectively). Further, in some embodiments, the center-to-center distance F, I of adjacent color wells in a display pixel 209 may be about 360 microns (although a larger or smaller distance may be employed). Although only the arrangement of print heads 201-205 in one set 109 of the apparatus 108 for inkjet printing is illustrated in FIG. 2B, it should be understood that print heads in remaining sets 109 of the apparatus 108 may be arranged in a similar manner.

The offsetting may occur at the time the set 109 is calibrated and configured to print onto a particular display pixel layout of a display object. Alternatively, the offsetting may be performed during printing to accommodate different display objects or other requirements. The set 109 may include and/or be coupled to a driver to independently move the print heads to create the offset.

In some embodiments, multiple sets 109 of print heads may be employed simultaneously in a single print pass. For example, in a system for inkjet printing 101 according to the present invention, three sets 109 of print heads, each including three print heads (for a total of nine prints heads) may be arranged side by side and independently adjustable in a lateral direction. Thus, in operation, the simultaneous use of nine print heads according to the present invention may result in as few as one third the number of print passes being required to complete printing of a series of display objects 107 as compared to conventional systems.

In some embodiments, multiple sets 109 may be employed to print on different display objects 107 and/or different substrates 105 simultaneously. For example, when printing on a substrate 105 that has a display object layout of three display objects 107 (e.g., three columns) by four display objects 107 (e.g., four rows), one set 109 per column of display objects 107 may be used to concurrently print each of the display objects 107 in a column. Thus, each set 109 of print heads may print a different column of display objects 107. Note that when printing on a substrate 105 that has a display object layout of, for example, five display objects 107 (e.g., five columns) by six display objects 107 (e.g., six rows), five sets 109 may be used concurrently to print the color filters in the most optimal manner.

In all cases, the sets 109 and/or individual print heads 201-205 may be independently adjustable rotationally and in a lateral direction (e.g., along the x-axis, perpendicular to the print direction) to allow each set to be aligned with a different display object 107 and/or column of display objects 107. The bridge 111 may also be adjustable rotationally to align each set 109 to a different display object 107 and/or column of display objects 107. In some embodiments, all or a subset of all the sets 109 may concurrently print a single display object 107, for example, when a display object 107 is particularly large. Also note that the sets 109 may include a number of print heads that corresponds with the number of different color inks that may be used. In other words, if a display object 107 includes ‘X’ number of colors, the sets 109 may include X print heads, one print head for each of the X colors. In a particular embodiment, the sets 109 may include six print heads, each print head for each of red, green, blue, yellow, magenta and cyan. It is found that the use of the six colors (R, G, B, Y, M, C) in combination can replicate a full range or gamut of colors to high degree of accuracy.

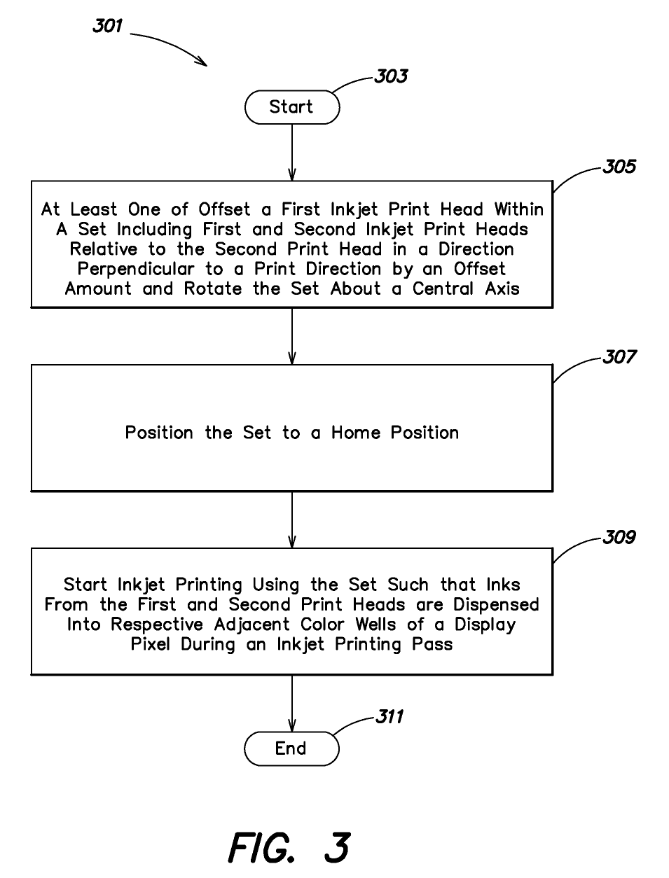

The operation of the system for inkjet printing is now described with reference to FIGS. 1-2B and with reference to FIG. 3, which illustrates a method 301 of inkjet printing in accordance with an embodiment of the present invention. With reference to FIG. 3, in step 303 the method 301 begins. In step 305, at least one of a first inkjet print head within a set including first and second inkjet print heads is offset relative to the second print head in a direction perpendicular to a print direction by an offset amount. The set 109 is then rotated about a central axis. More specifically, the first inkjet print head 201 may be offset (e.g., via hardware or software) relative to the second print head 203 by an offset amount (e.g., a distance) D along a longitudinal axis of the print head 203. In this manner, the first print head 201 is offset from the second print head 203 in a direction (e.g., along the x-axis) perpendicular to the print direction (e.g., along the y-axis) so that a center-to-center distance E in the direction perpendicular to the printing direction between corresponding nozzles 206a, 206b of the first and second print heads 201-203 is approximately equal to a center-to-center distance F of adjacent color wells 207a, 207b of the display pixel 209 into which ink will be dispensed. Another print head (e.g., a third print head 205) may be offset from the second print head 203 in a similar manner.

The set 109 also may be rotated about the central axis (e.g., by an angle θ) such that a center-to-center distance A between adjacent nozzles (e.g., 206a, 208a) of a print head (e.g., 201) within the set 109 in a direction (e.g., along the x-axis) perpendicular to a print direction (e.g., along the y-axis) is substantially equal to the display pixel width B (FIG. 2B). By rotating the set 109 about a central axis 113 (e.g., by an angle θ), all print heads 201-205 included in the set 109 are rotated by the angle θ. Alternatively, in some embodiments, one or more of the print heads 201-205 may be rotated by the angle θ about respective central axes of such print heads 201-205 to achieve the above result.

In this manner, the print heads 201-205 in the set 109 are arranged for inkjet printing in accordance with an embodiment of the present invention. Thereafter, step 307 is performed.

In step 307, the set is positioned to a home position. For example, the substrate support 103 may be employed to move the substrate 105 to a position from which the apparatus 108 including the set 109 may start inkjet printing (e.g., the home position). The home position may be selected such that the apparatus 108 does not omit display pixels 209 on the display object 107 and may dispense ink to display pixels 209 on the display object 107 in an orderly fashion during inkjet printing using one or more printing passes. In some embodiments, this step 307 may be repeated for each of N sets 109 of print heads for each of N display objects 107 (or N columns of display objects 107) on the substrate 105. In some embodiments, each set 109 may be adjusted both laterally (e.g., along the x-axis) and along the print direction (e.g., along the y-axis) so as to position the different sets 109 so that they may print without a gap between the sets 109.

In step 309, inkjet printing using the set 109 is started such that inks from the first and second print heads are dispensed into respective adjacent color wells of a display pixel during an inkjet printing pass. For example, different inks (e.g., inks of different colors) may be dispensed from the first and second print heads 201-203, respectively, into adjacent color wells (e.g., 207a, 207b) during the printing pass. Although only one set is shown in FIGS. 2A-2B, it should be understood that a plurality of sets 109 may be employed to dispense ink into display pixels 209 of display objects 107 during inkjet printing. One or more printing passes may be employed to dispense ink into the display pixels 209 included in the display objects 107 of the substrate 105. Because inks from different print heads 201-205 (e.g., different inks) may be dispensed into adjacent color wells (e.g., 207a, 207b) of display pixels 209 in a display object 107 during a single printing pass using the present methods and apparatus, a total number of printing passes required to dispense ink into display pixels 209 on the substrate 105 may be reduced compared to conventional inkjet printing systems. Thereafter, in step 311, the method 301 ends.

Through use of the method 301 inkjet printing may be improved by reducing a total number of printing passed required to dispense inks into display pixels 209 of display objects 107 included in a substrate 105. Compared to conventional systems, the present method improves inkjet printing efficiency and may reduce required maintenance.

As mentioned above, FIG. 4 depicts an arrangement of six sets 401A & B; 403A & B; 405A & B; 407A & B; 409A & B; and 411A & B of two print heads each. In this configuration, print heads in the same set may be aligned so that different print heads deposit ink (e.g., the same color ink) in different display pixels.

As shown in the example configuration of FIG. 4, the system may additionally include one or more cameras 413A, 413B (two depicted) that are adapted to allow examination of the substrate and/or ink deposited by either print heads mounted on the front of the bridge 111 or on the rear of the bridge 111 immediately before or after deposition. The cameras 413A, 413B may be mounted in print head carriages in the same manner in which print heads are mounted such that each camera 413A, 413B may be moved independently of each other and the print heads. Thus, the cameras 413A, 413B may be moved to either lead or trail any of the print heads as the substrate is moved below the print heads. Such a cameras 413A, 413B may be employed to align a substrate on the stage using alignment marks 415 on the substrate, to help determine ink drop locations, and/or to help calculate offsets for print head positioning. An example of a camera including an imaging system that may be suitable for use with the present invention may include the model CDC-200 Camera coupled to a model MVS-8100D Frame Grabber and associated software commercially available from Cognex Corporation of Natick, Mass. In some embodiments, the cameras 413A, 413B may include an automatic focus feature, a 100× to 200× zoom lens (e.g., a microscope lens), computer interface logic, and/or automation software. Other camera and/or camera systems including analog and/or digital CCD-based cameras or any other suitable sensor and/or detector device may be used. Other details regarding methods of using cameras and cameras that may be used in systems for inkjet printing can be found in previously incorporated U.S. Provisional Patent Application No. 60/703,146.

Turning to FIG. 5, an additional example configuration for printing with multiple sets of multiple print heads is depicted. Note that, as depicted in the drawing, individual print heads may be rotated and/or moved laterally independently of each other. By rotating the heads, the pitch (e.g., spacing in the X-direction) of the columns of deposited ink drops may be adjusted.

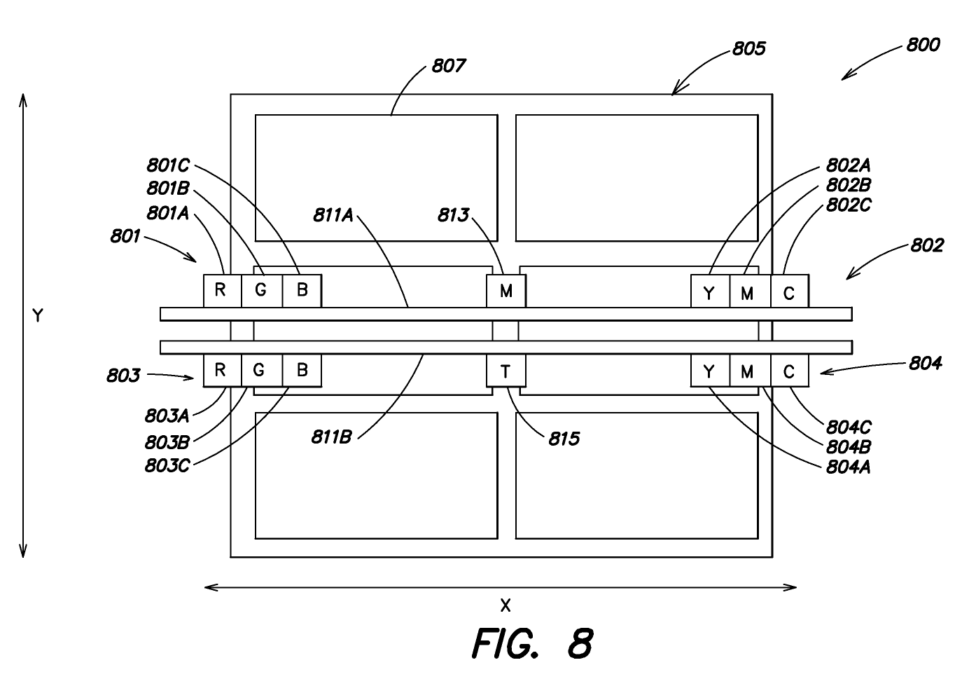

FIG. 8 depicts an additional arrangement 800 of four sets 801, 802, 803, 804, each including three print heads: 801A, 801B, 801C; 802A, 802B, 802C; 803A, 803B, 803C; and 804A, 804B, 804C. Sets of print heads 801 and 802 are disposed on a first bridge 811A and sets of print heads 803 and 804 are disposed on a second bridge 811B. In the example arrangement shown, the dual sets of print heads disposed on each of the bridges 801/802, 803/804 provide jetting of six colors of ink: red (R), green (G), blue (B), yellow (Y), magenta (M) and cyan (C). Thus, print head 801A may jet red ink, print head 801B may jet green ink, print head 801C may jet blue ink, print head 802A may jet yellow ink, print head 802B may jet magenta ink, and print head 802C may jet cyan ink. The print heads of sets 803 and 804 may be configured similarly. In this manner the display object(s) 807 on the substrate(s) 805 may be filled with all six colors. The six colors may be deposited in alternating or other arrangements in sub-pixels of a display object in a manner similar to the deposition of red, green and blue as described above. It is found that use of six colors enables a more accurate rendition of the entire range or gamut of colors in a display. Printing quality can be measured and verified using a microscope (M) 813 and a thickness measuring system (T) 815 which may be positioned on the middle (in the x-axis direction) of bridges 811A and 811B respectively so as to provide access the entire substrate 805.

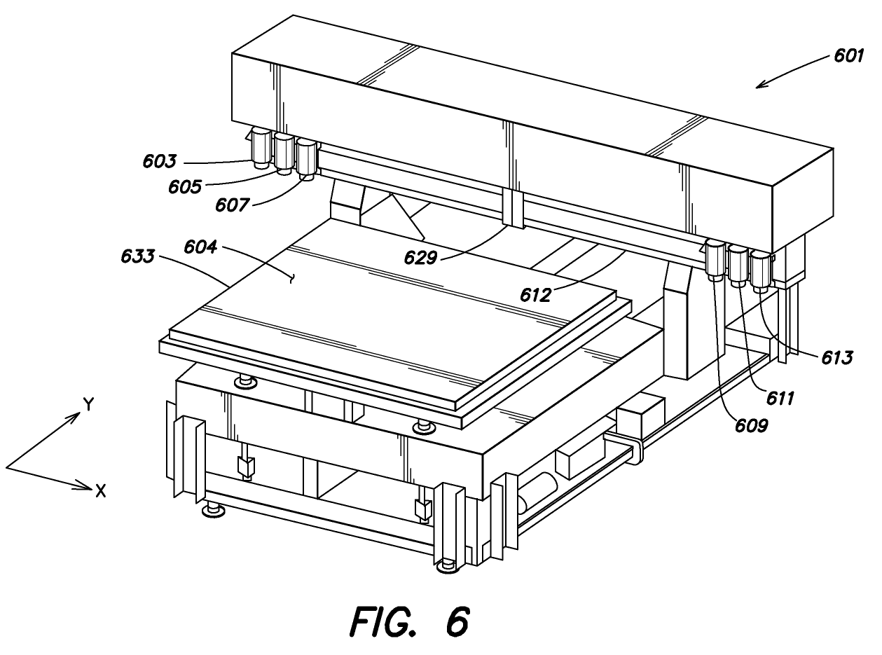

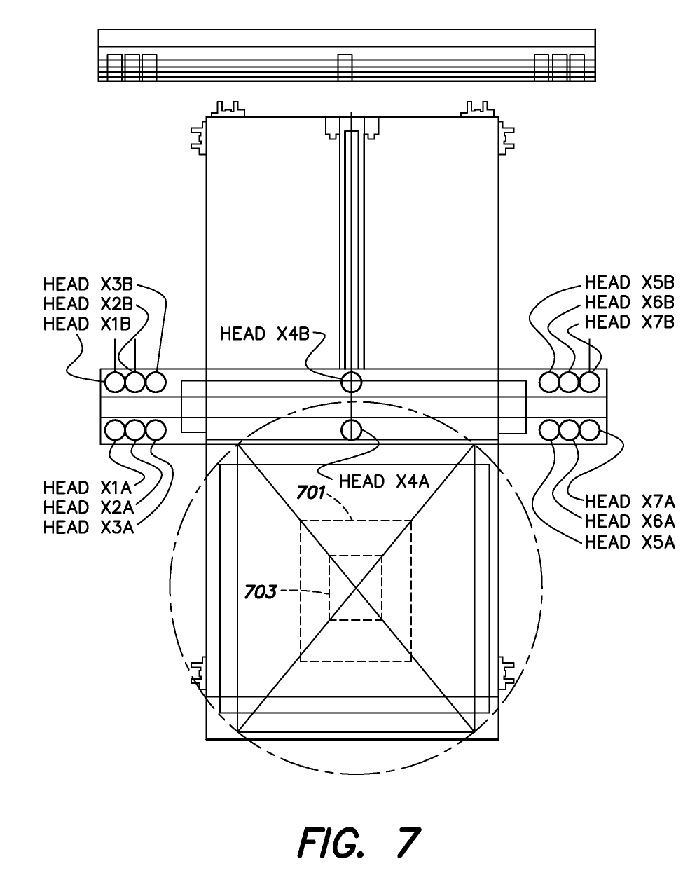

Turning to FIGS. 6 and 7, a perspective view and plan views, respectively, of a system 601 for inkjet printing that includes twelve inkjet heads 603-625 and two cameras, microscopes or other suitable devices 627-629 are depicted. Note that in FIG. 6 only six print heads 603-613 and one camera or microscope 629 mounted on the front of the bridge 611 are visible. The other six print heads 615-625 and camera or microscope 627 are mounted on the rear of the bridge 612 and thus are obscured by the bridge 612. The print heads 603-625 and/or cameras 627-629 are moveable at least along the X-axis direction. FIG. 7 provides a top view of the system 601. The large dashed circle 631 represents the furthest out points (e.g., the corners) of the largest sized substrate 604 that the system 601 may need to accommodate as the substrate 604 is rotated (e.g., while being aligned or otherwise processed). As indicated in previously incorporated U.S. patent application Ser. No. 10/781,953, sets of clamps or pushing devices may be used to align and position one or more substrates 604 on a support stage 633 of the inkjet printing system 601. The number and size of the pushing devices may be selected based upon the size and number of substrates 604 to be aligned.

Further, note that in some embodiments, the support stage 633 may include one or more vacuum chuck or hold-down regions 701, 703 to help maintain the position of the substrate(s) 604 once aligned. The vacuum chuck regions 701, 703 are depicted in FIG. 7 as dashed rectangular areas disposed in a concentric arrangement to accommodate various differently sized substrates. In other words, only region 703 may be activated for holding a relatively small substrate 604 and both regions 701, 703 may be activated for large substrates 604. In some embodiments, the regions 701, 703 may have other shapes and may be disposed in, for example, quadrants or columns on the stage 633.

The example system depicted in FIGS. 6 and 7 is adapted to efficiently process different sized substrates and display objects. For example, the system may accommodate ‘20K’ 1300×1500 mm² (0.7t) substrates which, for example, may be used to manufacture various display objects such as eight 27″ (1366×768 resolution) WXGA displays, six 32″ (1366×768 resolution) WXGA displays, three 37″ (1920×1080 resolution) HDTV displays, or two 56″ (3840×2160 resolution) QHDTV displays. Other larger and smaller size substrates and display objects may be processed by the inkjet system of the present invention. Thus, the capacity and configuration of the examples described herein provide the versatility to efficiently process a wide range of substrates.

In employing multiple sets of print heads in a printing operation (e.g., twelve print heads as shown and/or indicated in FIGS. 4, 5 and 8), it is useful to determine how to execute the jetting of ink onto the display object(s) of the substrate(s) in the fewest number of print passes possible in order to maximize throughput. This determination depends, among other possible factors, upon the size and configuration of display object(s) and the size and configuration of the substrate(s). In one or more embodiments, such a determination may involve calculation of: a system throughput time, a minimum number of printing passes required based on the number of print heads employed (based in part on the display object and substrate configuration), and initial print head printing positions. A number of other parameters and factors such as parking time, the size of the print heads, etc. may be employed in such calculations. It is noted, however, that other throughput optimization techniques may be used based on the same or other factors. The determination may be performed by one or more controllers (not shown) coupled to each of the sets 801, 802, 803, 804. An embodiment of a controller that may be used in the context of the present invention is described in previously incorporated U.S. patent application Ser. No. 11/466,507.

The foregoing description discloses only exemplary embodiments of the invention. Modifications of the above disclosed apparatus and methods which fall within the scope of the invention will be readily apparent to those of ordinary skill in the art. For instance, in one or more embodiments, the inkjet heads 201-205, 603-625 may move during printing while the substrate 105 remains stationary. In some embodiments, the apparatus and methods of the present invention may be applied to semiconductor processing and/or electronic device manufacturing. For example, resist patterns may be inkjetted onto substrates 105 which may include glass, polymers, semiconductors, and/or any other suitable materials that are practicable. Further, the present invention may also be applied to spacer formation, polarizer coating, and nanoparticle circuit forming. Thus, the jetted material may include ink, polymers, or any other suitable material that is practicable.

Accordingly, while the present invention has been disclosed in connection with exemplary embodiments thereof, it should be understood that other embodiments may fall within the spirit and scope of the invention, as defined by the following claims.

The invention claimed is:

1. A system for inkjet printing, comprising:
a first set including a first inkjet print head having a first plurality of nozzles adapted to selectively dispense a first ink, and a second inkjet print head having a second plurality of nozzles adapted to selectively dispense a second ink;
a second set including a third inkjet print head having a third plurality of nozzles adapted to selectively dispense a third ink and a fourth inkjet print head having a fourth plurality of nozzles adapted to selectively dispense a fourth ink; and
a stage adapted to support the substrate and transport the substrate below the first and second sets during a printing pass;
wherein the first set is adapted to dispense the first and second inks into respective adjacent color wells of a display pixel on a substrate and the second set is adapted to dispense the third and fourth inks into respective adjacent color wells of a display pixel on a substrate.

2. The system of claim 1 further comprising a camera coupled to the stage and adapted to at least one of:
align the substrate on the stage;
determine a location for an ink drop; and
calculate an offset for a print head.

3. The system of claim 1 wherein the stage further comprises at least one of a vacuum chuck and a hold down region to maintain substrate alignment.

4. The system of claim 1 wherein the first ink has a different color than the second ink, and the third ink has a different color than the fourth ink.

5. The system of claim 1, further comprising:
a first bridge adapted to support at least one of the first set and the second set above the substrate.

6. The system of claim 5, further comprising:
a third set including a fifth inkjet print head having a fifth plurality of nozzles adapted to selectively dispense a fifth ink and a sixth inkjet print head having a sixth plurality of nozzles adapted to selectively dispense a sixth ink; and
a fourth set including a seventh inkjet print head having a seventh plurality of nozzles adapted to selectively dispense a seventh ink and an eighth inkjet print head having an eighth plurality of nozzles adapted to selectively dispense an eighth ink.

7. The system of claim 6, further comprising:
a second bridge adapted to support at least one of the third set and the fourth set above the substrate.

8. The system of claim 7, wherein the first set includes a ninth inkjet print head, the second set includes a tenth inkjet print head, the third set includes an eleventh inkjet print head, and the fourth set includes a twelfth inkjet print head.

9. The system of claim 8, wherein the inkjet print heads included in any of the first, second, third and fourth sets are each adapted to print a different color.

10. The system of claim 9, wherein the three print heads included in each of the first, second, third and fourth sets are adapted to print red, green and blue ink respectively.

11. The system of claim 10, wherein all of the first, second, third and fourth sets are adapted to be used during a printing pass, reducing a number of times the substrate is required to pass under the first, second, third and fourth sets during a printing operation.

12. The system of claim 11, wherein all of the first, second, third and fourth sets are adapted to be used simultaneously during a print pass.

13. The apparatus of claim 7, wherein the first and second bridges are aligned approximately parallel to a direction in which the stage transports the substrate.

14. The apparatus of claim 13, wherein the first set is adapted to be offset a distance along the first bridge from the second set and the third set is adapted to be offset a distance along the second bridge from the fourth set.

15. A method of inkjet printing, comprising:
grouping a first plurality of inkjet print heads into a first set;
grouping a second plurality of inkjet print heads into a second set;
moving a substrate under the first and second sets in a print direction during a printing pass; and
employing both the first set and the second set to dispense ink onto a display object on a substrate during the printing pass.

16. The method of claim 15, wherein employing both the first set and the second set comprises employing all of the plurality of inkjet print heads in both the first set and the second set during the printing pass.

17. The method of claim 16, further comprising:
aligning the substrate relative to the first and second sets;
determining a location for an ink drop dispensed from one of the print heads included in one of the first and second sets; and
calculating an offset for a print head grouped in one of the first and second sets.

18. The system of claim 16, further comprising:
applying a vacuum force to maintain a substrate alignment.

19. The method of claim 16 further comprising:
reducing a number of times the substrate is moved under the first and second sets such that ink is dispensed from the first and second sets on the substrate.

20. The method of claim 16, wherein each of the inkjet print heads included in the plurality of inkjet print heads grouped in the first set dispenses a different color of ink and each of the inkjet print heads included in the plurality of inkjet print heads grouped in the second set dispenses a different color of ink.

21. The method of claim 20, further comprising:
grouping a third plurality of inkjet print heads into a third set;
grouping a fourth plurality of inkjet print heads into a fourth set; and
employing both the third set and the fourth set to dispense ink onto a display object on a substrate during the printing pass.

22. The method of claim 21, further comprising:
arranging the first set and the second set at a first position along the print direction while offsetting the first and second sets in a direction perpendicular to the print direction; and
arranging the third set and the fourth set at a second position along the print direction while offsetting the third and fourth sets in a direction perpendicular to the print direction;
wherein the first position along the print direction is different from the second position along the print direction.

23. The method of claim 22, wherein the first, second, third and fourth sets each include three print heads.

24. An apparatus for inkjet printing, comprising:
a first set including a first inkjet print head having a first plurality of nozzles adapted to selectively dispense a first ink, and a second inkjet print head having a second plurality of nozzles adapted to selectively dispense a second ink; and
a second set including a third inkjet print head having a third plurality of nozzles adapted to selectively dispense a third ink and a fourth inkjet print head having a fourth plurality of nozzles adapted to selectively dispense a fourth ink;
wherein the first set is adapted to dispense the first and second inks into respective adjacent color wells of a display pixel on a substrate and the second set is adapted to dispense the third and fourth inks into respective adjacent color wells of a display pixel on a substrate.
